(19) United States
(12) Patent Application Publication
(10) Pub. No.: US 2016/0132779 A1
(43) Pub. Date: May 12, 2016

(54) HYBRID RULE REASONING APPARATUS AND METHOD THEREOF

(71) Applicant: Korea Institute of Science and Technology Information, Daejeon (KR)

(72) Inventors: Seungwoo Lee, Daejeon (KR); Chang Hoo Jeong, Daejeon (KR); Jung Ho Um, Jeollabuk-do (KR); Taehong Kim, Daejeon (KR); Hanmin Jung, Daejeon (KR); Won Kyung Sung, Daejeon (KR)

(21) Appl. No.: 14/572,192

(22) Filed: Dec. 16, 2014

(30) Foreign Application Priority Data
Nov. 6, 2014 (KR) 10-2014-0153763

(51) Int. Cl. G06N 5/04

(52) U.S. Cl. CPC G06N 5/046

(57) ABSTRACT

A hybrid rule reasoning apparatus and a method thereof includes: a reasoning rule classification unit for classifying an input reasoning rule into at least one of a schema rule, an instance rule, and a mixed rule; a memory-based reasoning unit for performing reasoning by applying a schema rule to a previously stored schema triple and specifying a mixed rule into an instance rule by applying the mixed rule to the schema triple; and a disk-based distributed/parallel reasoning unit for performing reasoning by applying the instance rule specified by the memory-based reasoning unit or the instance rule classified by the reasoning rule classification unit to a previously stored instance triple.

### BACKGROUND OF THE INVENTION

1. Field of the Invention

The present invention relates to a hybrid rule reasoning apparatus and a method thereof, and more specifically, to a hybrid rule reasoning apparatus and a method thereof, which perform reasoning by combining memory-based reasoning and disk-based distributed/parallel reasoning according to the type of a reasoning rule.

2. Background of the Related Art

Ontology reasoning means a process of inducing implicit knowledge from explicitly given ontology knowledge. The ontology knowledge is described in a language such as RDF, RDFS, OWL or the like in a semantic web, and since the ontology knowledge is a set of RDF triples, a rule-based reasoning means a process of deriving a new triple by applying a given rule in a set of explicitly given RDF triples.

Recently, as the ontology knowledge is created by several organizations more and more along with the expansion of semantic web techniques and the scale of the ontology knowledge gradually increases, an ontology reasoning system (hereinafter, simply referred to as a ‘reasoning system’) of a large scale which can efficiently store and reason a large number of RDF triples (hereinafter, simply referred to as a ‘triple’) is required earnestly.

Although ‘a reasoning method utilizing Rete algorithm’ (hereinafter, referred to as a ‘memory reasoning method’) has been proposed thereby, there is a problem in that memory is excessively required in return for decreasing a repetitive pattern matching process by efficiently performing pattern matching. That is, in a reasoning system which requires tens of billions of triple processes, a problem of requiring a large capacity of memory has been raised since both α-memory and β-memory for storing data created in the process of applying a reasoning rule to the triples should be stored in physical memory (e.g., RAM).

Although ‘a reasoning method utilizing a DBMS’ (hereinafter, simply referred to as ‘a DBMS reasoning method’) proposed in the prior art to solve the problem is suitable for storing a large number of triples, it has a problem of inefficiency in repetitively reading and writing DB tables in a reasoning process.

Like this, the memory-based reasoning technique of the prior art has a limit in large-scale reasoning since all the reasoning is processed in memory, and disk-based distributed and parallel reasoning has a problem in that since all reasoning is processed based on a disk and even those which can be processed in memory repetitively access the disk, an opportunity for additionally improving performance is lost.

### SUMMARY OF THE INVENTION

Therefore, the present invention has been made in view of the above problems, and it is an object of the present invention to provide a hybrid rule reasoning apparatus and a method thereof, which combine memory-based reasoning and disk-based distributed/parallel reasoning according to the type of a reasoning rule such as a schema rule, an instance rule, a mixed rule or the like.

Another object of the present invention is to provide a hybrid rule reasoning apparatus and a method thereof, which combines advantages of memory-based reasoning capable of rapidly reasoning a small task (a schema rule) in memory with advantages of disk-based distributed/parallel reasoning capable of reasoning a large task (an instance rule) in a distributed and parallel method according to the characteristic of a reasoning rule.

To accomplish the above objects, according to one aspect of the present invention, there is provided a hybrid rule reasoning apparatus including: a reasoning rule classification unit for classifying an input reasoning rule into at least one of a schema rule, an instance rule, and a mixed rule; a memory-based reasoning unit for performing reasoning by applying a schema rule to a previously stored schema triple and specifying a mixed rule into an instance rule by applying the mixed rule to the schema triple; and a disk-based distributed/parallel reasoning unit for performing reasoning by applying the instance rule specified by the memory-based reasoning unit or the instance rule classified by the reasoning rule classification unit to a previously stored instance triple.

The hybrid rule reasoning apparatus may further include a triple storage unit for storing schema triples and instance triples.

The reasoning rule classification unit may classify a reasoning rule as a schema rule when a condition part of the reasoning rule is configured of only schema triple patterns, classify a reasoning rule as an instance rule when the condition part of the reasoning rule is configured of only instance triple patterns, and classify a reasoning rule as a mixed rule when the condition part of the reasoning rule is a mixture of schema triple patterns and instance triple patterns.

The memory-based reasoning unit may rewrite the mixed rule into a new rule having only schema triple patterns of the mixed rule on a left side of the rule and having a rule removing schema triple patterns from an original rule on a right side and specify the mixed rule as an instance rule by applying the schema triple to the rewritten mixed rule.

According to another aspect of the present invention, there is provided a hybrid rule reasoning method of a hybrid rule reasoning apparatus, the method including the steps of: (a) classifying an input reasoning rule into at least one of a schema rule, an instance rule, and a mixed rule; and (b) reasoning the classified reasoning rule in a memory-based reasoning method or a disk-based distributed/parallel reasoning method.

The step (a) may include the steps of classifying a reasoning rule as a schema rule when a condition part of the reasoning rule is configured of only schema triple patterns, classifying a reasoning rule as an instance rule when a condition part of the reasoning rule is configured of only instance triple patterns, and classifying a reasoning rule as a mixed rule when a condition part of the reasoning rule is a mixture of schema triple patterns and instance triple patterns.

The step (b) may include the steps of inducing, in a case of the schema rule, a new schema triple by applying the memory-based reasoning method to the schema rule, converting, in a case of the mixed rule, the mixed rule into an instance rule by applying the memory-based reasoning method to the mixed rule, and inducing a new instance triple by applying the disk-based distributed/parallel reasoning method to the converted instance rule, and inducing, in a case of the instance rule, a new instance triple by applying the disk-based distributed/parallel reasoning method to the instance rule.

According to still another aspect of the present invention, there is provided a computer-readable recording medium recording a program for implementing a hybrid rule reasoning method of a hybrid rule reasoning apparatus, the method including the steps of: when the program is executed by the hybrid rule reasoning apparatus, (a) classifying an input reasoning rule into at least one of a schema rule, an instance rule, and a mixed rule; and (b) reasoning the classified reasoning rule in a memory-based reasoning method or a disk-based distributed/parallel reasoning method.

### BRIEF DESCRIPTION OF THE DRAWINGS

FIG. 1 is a block diagram schematically showing the configuration of a hybrid rule reasoning apparatus according to an embodiment of the present invention.

FIG. 2 is a view showing a hybrid rule reasoning method according to an embodiment of the present invention.

### DESCRIPTION OF SYMBOLS

100: Hybrid rule reasoning apparatus
110: Reasoning rule classification unit
120: Memory-based reasoning unit
130: Disk-based distributed/parallel reasoning unit
140: Triple storage unit

### DETAILED DESCRIPTION OF THE PREFERRED EMBODIMENT

Details of the objects and technical configuration of the present invention described above and operational effects according thereto will be clearly understood hereinafter by the detailed description with reference to the accompanying drawings attached in the specification of the present invention.

Hereinafter, ‘a hybrid rule reasoning apparatus and a method thereof’ according to the present invention will be described in detail with reference to accompanying drawings. The disclosed embodiments are provided to enable those skilled in the art to easily understand the scope of the present invention, and the present invention is not limited by such embodiments. Moreover, matters illustrated in the drawings are schematized in order to describe or explain the embodiments of the present invention more easily, and hence, may be different from forms embodied actually.

Meanwhile, the constitutional components expressed below are merely examples for implementing the present invention. Accordingly, other components may be used in other implementations of the present invention without departing from the spirit and scope of the present invention. In addition, although each component can be implemented only in a pure hardware or software configuration, it also can be implemented by combining various hardware or software configurations performing the same function. In addition, two or more components may be implemented together by one piece of hardware or software.

In addition, the expression of ‘including’ an element is an expression of an ‘open-ended’ which merely refers to existence of a corresponding component, and it should not be construed as precluding additional components.

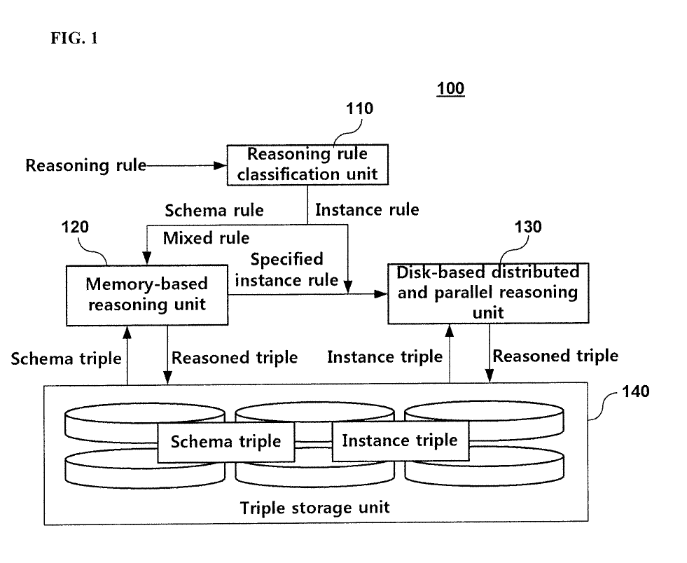

FIG. 1 is a block diagram schematically showing the configuration of a hybrid rule reasoning apparatus according to an embodiment of the present invention.

Referring to FIG. 1, a hybrid rule reasoning apparatus 100 includes a reasoning rule classification unit 110, a memory-based reasoning unit 120, a disk-based distributed/parallel reasoning unit 130, and a triple storage unit 140.

The reasoning rule classification unit 110 classifies an input reasoning rule into a schema rule, an instance rule, a mixed rule, a generic rule or the like.

A reasoning rule is configured of a condition part and a conclusion part, and the condition part and the conclusion part are respectively configured of one or more triple patterns. Referring to Tables 1 and 2, in the exemplified reasoning rules, the left side of ‘->’ corresponds to the condition part, and the right side of ‘->’ corresponds to the conclusion part. Although a triple pattern is configured of <subject, predicate, object> like a triple, the subject, the predicate and the object may be a variable, not a constant, respectively. A reasoning rule expresses that a triple corresponding to the conclusion part may be reasoned as a new fact when facts can be applied to triple patterns of the condition part, and reasoning is a process of obtaining a new (reasoned) triple by applying a reasoning rule to an existing triple.

The reasoning rule classification unit 110 classifies a reasoning rule into a schema rule, an instance rule, a mixed rule, a generic rule or the like according to the type of a triple pattern in the condition part.

That is, when the condition part of a reasoning rule is configured of only schema triple patterns that can be matched only to a schema triple, the reasoning rule classification unit 110 classifies the reasoning rule as a schema rule. That is, when the condition part is configured of only triples defining a class or a property, the reasoning rule classification unit 110 classifies the reasoning rule as a schema rule.

For example, referring to Table 1, rdfs 5 may be a schema rule since the condition part ‘(p rdfs:subPropertyOf q) (q rdfs:subPropertyOf r)’ is configured of only triples defining a property, and rdfs 6 and rdfs 8 may be a schema rule respectively since the condition parts ‘(p rdf:type rdf:Property)’ and ‘(c rdf:type rdfs:Class)’ are configured of only triples defining a class and a property. In addition, rdfs 10 may be a schema rule since the condition part ‘(c rdf:type rdfs:Class)’ is configured of only a triple defining a class, and rdfs 11 may be a schema rule since the condition part ‘(c rdfs:subClassOf d) (d rdfs:subClassOf e)’ is configured of only triples defining a class. In addition, rdfs 12 may be a schema rule since the condition part ‘(p rdf:type rdfs:ContainerMembershipProperty)’ is configured of only a triple defining a property.

TABLE 1
RDF and RDFS rules

| id | | entailment rules |
|---|---|---|
| rdf | 1 | (u p v) → (p rdf:type rdf:Property) |
| | 2 | (u p v) (if v is a XML literal and _:n is a bland node allocated to v) → (_:n rdf:type |
| | | rdf:XMLLiteral) |
| rdfs | 1 | (u p v) (if v is a plain literal and _:n is a bland node allocated to v) → (_:n rdf:type |
| | | rdfs:Literal) |
| | 2 | (p rdfs:domain c) (u p v) → (u rdf:type c) |
| | 3 | (p rdfs:range c) (u p v) → (v rdf:type c) |
| | 4a | (u p v) → (u rdf:type rdfs:Resource) |
| | 4b | (u p v) → (v rdf:type rdfs:Resource) |
| | 5 | (p rdfs:subPropertyOf q) (q rdfs:subPropertyOf r) → (p rdfs:subPropertyOf r) |
| | 6 | (p rdf:type rdf:Property) → (p rdfs:subPropertyOf p) |
| | 7 | (p rdfs:subPropertyOf q) (u p v) → (u q v) |
| | 8 | (c rdf:type rdfs:Class) → (c rdfs:subClassOf rdfs:Resource) |
| | 9 | (c rdfs:subClassOf o) (c rdf:type c) → (u rdfs:type d) |
| | 10 | (c rdf:type rdfs:Class) → (c rdfs:subClassOf c) |
| | 11 | (c rdfs:subClassOf o) (d rdfs:subClassOf e) → (c rdfs:subClassOf e) |
| | 12 | (p rdf:type rdfs:ContainerMembershipProperty) → (p rdfs:subPropertyOf rdfs:member) |
| | 13 | (c rdf:type rdfs:Datatype) → (c rdfs:subClassOf rdfs:Literal) |

Referring to Table 2, owl-horst 9 may be a schema rule since the condition part ‘(c rdf:type owl:Class) (c owl:sameAs d)’ is configured of only triples defining a class, and owl-horst 10 may be a schema rule since the condition part ‘(p rdf:type rdf:Property) (p owl:sameAs q)’ is configured of only triples defining a property. In addition, owl-horst 12a may be a schema rule since the condition part ‘(c owl:equivalentClass d)’ is configured of only a triple defining a class, and owl-horst 12b may be a schema rule since the condition part ‘(c owl:equivalentClass d)’ is configured of only a triple defining a class. In addition, owl-horst 12c may be a schema rule since the condition part ‘(c rdfs:subClassOf d) (d rdfs:subClassOf c)’ is configured of only triples defining a class, and owl-horst 13a, owl-horst 13b and owl-horst 13c may be a schema rule respectively since the condition parts (p owl:equivalentProperty q) of owl-horst 13a, (p owl:equivalentProperty q) of owl-horst 13b, (p rdfs:subPropertyOf q) (q rdfs:subPropertyOf p) of owl-horst 13c are configured of only a triple defining a property.

TABLE 2
OWL Horst rules

| id | entailment rules |
|---|---|
| 1 | (p rdf:type owl:FunctionalProperty) (u p v) (u p w) → (v owl:sameAs w) |
| 2 | (p rdf:type owl:InverseFunctionalProperty) (u p w) (v p w) → (u owl:sameAs v) |
| 3 | (p rdf:type owl:SymmetricProperty) (u p v) → (v p u) |
| 4 | (p rdf:type owl:TransitiveProperty) (u p v) (v p w) → (u p w) |
| 5a | (u p v) → (u owl:sameAs u) |
| 5b | (u p v) → (v owl:sameAs v) |
| 6 | (u owl:sameAs v) → (v owl:sameAs u) |
| 7 | (u owl:sameAs v) (v owl:sameAs w) → (u owl:sameAs w) |
| 8a | (p owl:InverseOf q) (u p v) → (v q u) |
| 8b | (p owl:InverseOf q) (u q v) → (v p u) |
| 9 | (c rdf:type owl:Class) (u owl:sameAs d) → (c rdfs:subClassOf o) |
| 10 | (p rdf:type rdf:Property) (p owl:sameAs q) → (p rdfs:subPropertyOf q) |
| 11 | (u p v) (u owl:sameAs x) (v owl:sameAs y) → (x p y) |
| 12a | (c owl:equivalentClass o) → (c rdfs:subClassOf o) |
| 12b | (c owl:equivalentClass d) → (d rdfs:subClassOf c) |
| 12c | (c rdfs:subClassOf o) (d rdfs:subClassOf c) → (c owl:equivalentClass d) |
| 13a | (p owl:equivalentProperty q) → (p rdfs:subPropertyOf q) |
| 13b | (p owl:equivalentProperty q) → (q rdfs:subPropertyOf p) |
| 13c | (p rdfs:subPropertyOf q) (q rdfs:subPropertyOf p) → (p owl:equivalentProperty q) |
| 14a | (c owl:hasValue v) (c owl:onProperty p) (u p v) → (u rdf:type c) |
| 14b | (c owl:hasValue v) (c owl:onProperty p) (u rdf:type c) → (u p v) |
| 15 | (c owl:someValuesFrom d) (c owl:onProperty p) (u p v) (v rdf:type d) → (u rdf:type c) |
| 16 | (c owl:allValuesFrom d) (c owl:onProperty p) (u p v) (u rdf:type c) → (v rdf:type d) |

In addition, when the condition part of a reasoning rule is configured of only instance triple patterns that can be matched to an instance triple, the reasoning rule classification unit 110 classifies the reasoning rule as an instance rule. That is, when the condition part of the reasoning rule is configured of only instances describing a class (rdf:type) of an individual entity and a relation between entities, the reasoning rule classification unit 110 classifies the reasoning rule as an instance rule. Since the amount of the instance is immense, an instance rule may chiefly correspond to a user defined rule.

In addition, when the condition part of a reasoning rule is a mixture of a schema triple pattern and an instance triple pattern, the reasoning rule classification unit 110 classifies the reasoning rule as a mixed rule. For example, rules of rdfs 2, 3, 7 and 9 of Table 1 and owl-horst 1, 2, 3, 4, 8a, 8b, 14a, 14b, 15 and 16 of Table 2 may be mixed rules.

In addition, when the condition part of a reasoning rule has only one generic triple pattern such as (u p v), (x rdf:type c) or the like, the reasoning rule classification unit 110 classifies the reasoning rule as a generic rule. Since the condition part of the generic rule has only one triple pattern, reasoning can be made at any time by scanning previously stored triples only once. Accordingly, since the generic rule is not an important factor for performance, detailed descriptions regarding to a method of reasoning the generic rule will be omitted.

Like this, the reasoning rule classification unit 110 classifies a reasoning rule as a schema rule when the condition part of the reasoning rule is configured of only schema triple patterns, classifies a reasoning rule as an instance rule when the condition part of the reasoning rule is configured of only instance triple patterns, and classifies a reasoning rule as a mixed rule when the condition part of the reasoning rule is a mixture of schema triple patterns and instance triple patterns.

The memory-based reasoning unit 120 induces a new schema triple by applying a memory-based reasoning method to a schema rule. That is, the memory-based reasoning unit 120 induces a new schema triple by applying a schema rule to a schema triple stored in the triple storage unit 140. At this point, the memory-based reasoning unit 120 recursively performs this process until a new schema triple is not induced any more, and the reasoned schema triples may be maintained in memory (not shown) of the memory-based reasoning unit 120 as well as being stored in the triple storage unit 140 to be recursively applied to a reasoning rule. The memory-based reasoning unit 120 reads initial schema triples stored in the triple storage unit 140 and maintains the initial schema triples in internal memory in order to efficiently perform recursive reasoning and maintains the reasoned schema triples in the memory as well as storing in the triple storage unit 140.

In addition, the memory-based reasoning unit 120 specifies a mixed rule as an instance rule by applying a memory-based reasoning method to the mixed rule and provides the specified instance rule to the disk-based distributed/parallel reasoning unit 130. That is, the memory-based reasoning unit 120 converts a mixed rule into a specific instance rule by applying the mixed rule to a schema triple stored in the triple storage unit 140.

For example, when the mixed rule is ‘(p rdfs:subPropertyOf q) (u p v)→(u q v)’, the memory-based reasoning unit 120 rewrites a new rule having only schema triple patterns on the left side of the rule and having a rule removing schema triple patterns from an original rule on the right side, such as ‘(p rdfs:subPropertyOf q)→[(u p v)→(u q v)]’. Then, the memory-based reasoning unit 120 converts the mixed rule into an instance rule by applying the schema triple to the condition part ‘(p rdfs:subPropertyOf q)’ of the rewritten mixed rule. Through this process, the memory-based reasoning unit 120 converts the mixed rule into an instance rule.

The disk-based distributed/parallel reasoning unit 130 induces a new instance triple by applying the instance rule specified by the memory-based reasoning unit 120 or the instance rule classified by the reasoning rule classification unit 110 to an instance triple stored in the triple storage unit 140. At this point, the disk-based distributed/parallel reasoning unit 130 recursively performs this process until a new instance triple is not induced any more, and the reasoned instance triples may be stored in the triple storage unit 140 to be recursively applied to a reasoning rule.

The schema triples and the instance triples are stored in the triple storage unit 140.

The triple storage unit 140 is a space for storing schema triples and instance triples through a variety of data structures according to the characteristic of the schema, and the instance triples are stored after an ID of an integer type is assigned to each of the instance triples instead of a unique character string URI, and it is preferable that the instance triple is managed after mapping an assigned ID to a unique character string URI so that the unique character string URI mapped to a corresponding ID may be returned when an instance triple is returned to outside.

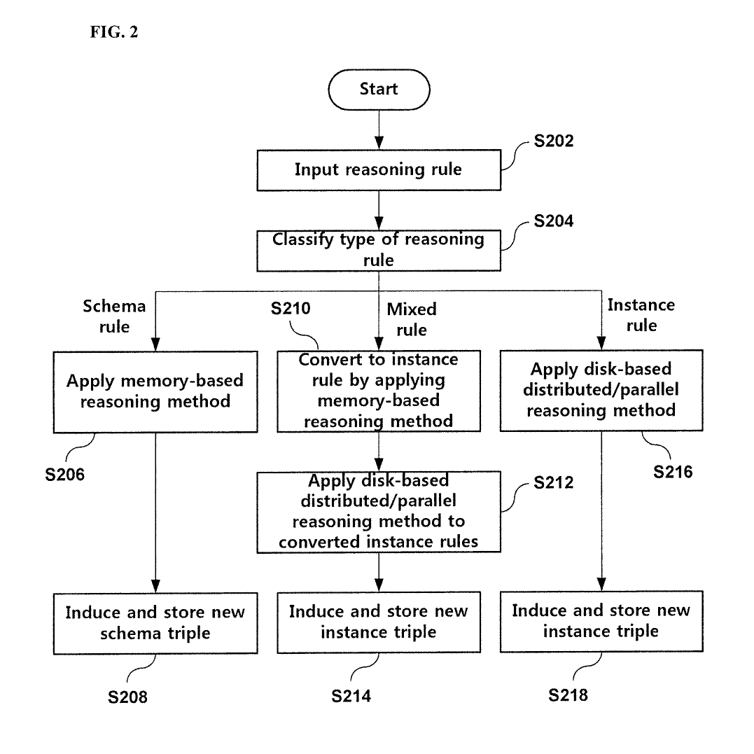

FIG. 2 is a view showing a hybrid rule reasoning method according to an embodiment of the present invention.

Referring to FIG. 2, if a reasoning rule is input (S202), the hybrid rule reasoning apparatus classifies the input reasoning rule into a schema rule, an instance rule, a mixed rule, a generic rule or the like according to the type of the triple pattern of the condition part (S204). At this point, the hybrid rule reasoning apparatus classifies a reasoning rule as a schema rule when the condition part of the reasoning rule is configured of only schema triple patterns, classifies a reasoning rule as an instance rule when the condition part of the reasoning rule is configured of only instance triple patterns, and classifies a reasoning rule as a mixed rule when the condition part of the reasoning rule is a mixture of schema triple patterns and instance triple patterns.

If step S204 is performed, the hybrid rule reasoning apparatus performs reasoning by combining memory-based reasoning and disk-based distributed/parallel reasoning according to the type of the reasoning rule.

Hereinafter, a method of reasoning each of the reasoning rules will be described in detail.

First, in the case of the schema rule, the hybrid rule reasoning apparatus induces and stores a new schema triple (S208) by applying a memory-based reasoning method to a schema rule (S206). That is, the hybrid rule reasoning apparatus induces a new schema triple by applying the schema rule to a previously stored schema triple. At this point, the hybrid rule reasoning apparatus recursively performs this process until a new schema triple is not induced any more, and the induced schema triples may be maintained in the memory of the memory-based reasoning unit as well as being stored in the triple storage unit to be recursively applied to a reasoning rule.

Next, in the case of the mixed rule, the hybrid rule reasoning apparatus converts the mixed rule into an instance rule by applying a memory-based reasoning method to the mixed rule (S210) and induces and stores a new instance triple (S214) by applying a disk-based distributed/parallel reasoning method to the converted instance rule (S212). That is, the hybrid rule reasoning apparatus converts the mixed rule into a specific instance rule by applying the mixed rule to a previously stored schema triple and induces a new instance triple by applying the converted instance rule to a previously stored instance triple. At this point, the hybrid rule reasoning apparatus recursively performs this process until a new instance triple is not induced any more, and the induced instance triples may be stored to be recursively applied to a reasoning rule.

Finally, in the case of the instance rule, the hybrid rule reasoning apparatus induces and stores a new instance triple (S218) by applying a disk-based distributed/parallel reasoning method to the instance rule (S216). That is, the hybrid rule reasoning apparatus induces a new instance triple by applying the instance rule to a previously stored instance triple. At this point, the hybrid rule reasoning apparatus recursively performs this process until a new instance triple is not induced any more, and the induced instance triples may be stored to be recursively applied to a reasoning rule.

Such a hybrid rule reasoning apparatus may improve overall performance of a reasoning engine by reducing disk access load when reasoning is performed in a distributed and parallel reasoning method by processing small tasks (schema rules) in advance in memory and specifying a mixed rule into an instance rule.

Such a hybrid rule reasoning method may be created as a program, and codes and code segments configuring the program may be easily reasoned by the programmers in the art. In addition, the program related to the hybrid rule reasoning method may be stored in an information storage medium (readable media) that can be read by an electronic device and read and executed by the electronic device.

According to the present invention, overall performance of a reasoning engine may be improved by reducing disk access load when reasoning is performed in a distributed and parallel reasoning method by processing small tasks (schema rules) in advance in memory and specifying a mixed rule into an instance rule.

In addition, compared to a method of the prior art, additional improvement of performance can be expected by applying disk-based reasoning to triples other than the triples processed in memory after those which can be processed in the memory are processed through memory-based reasoning in advance.

It is understood that the description is merely for illustrative purposes and the skilled persons in the art can modify the invention into other forms with ease without changing the technical scope and essential features of the invention. Thus, it should be construed that the described embodiments are not restrictive, but merely illustrative. The scope of the invention is disclosed in the accompanying claims rather than the description, and it is construed that the meaning and the scope of the claims, and all changes induced from the equivalence thereof are included in the scope of the invention.

What is claimed is:

1. A hybrid rule reasoning apparatus, the apparatus comprising:
a reasoning rule classification unit for classifying an input reasoning rule into at least one of a schema rule, an instance rule, and a mixed rule;
a memory-based reasoning unit for performing reasoning by applying a schema rule to a previously stored schema triple and specifying a mixed rule into an instance rule by applying the mixed rule to the schema triple; and
a disk-based distributed/parallel reasoning unit for performing reasoning by applying the instance rule specified by the memory-based reasoning unit or the instance rule classified by the reasoning rule classification unit to a previously stored instance triple.

2. The apparatus according to claim 1, further comprising a triple storage unit for storing schema triples and instance triples.

3. The apparatus according to claim 1, wherein the reasoning rule classification unit classifies a reasoning rule as a schema rule when a condition part of the reasoning rule is configured of only schema triple patterns, classifies a reasoning rule as an instance rule when the condition part of the reasoning rule is configured of only instance triple patterns, and classifies a reasoning rule as a mixed rule when the condition part of the reasoning rule is a mixture of schema triple patterns and instance triple patterns.

4. The apparatus according to claim 1, wherein the memory-based reasoning unit rewrites the mixed rule into a new rule having only schema triple patterns of the mixed rule on a left side of the rule and having a rule removing schema triple patterns from an original rule on a right side and specifies the mixed rule as an instance rule by applying the schema triple to the rewritten mixed rule.

5. Hybrid rule reasoning method of hybrid rule reasoning apparatus, the method comprising the steps of:
(a) classifying an input reasoning rule into at least one of a schema rule, an instance rule, and a mixed rule; and
(b) reasoning the classified reasoning rule in a memory-based reasoning method or a disk-based distributed/parallel reasoning method.

6. The method according to claim 5, wherein step (a) includes the steps of classifying a reasoning rule as a schema rule when a condition part of the reasoning rule is configured of only schema triple patterns, classifying a reasoning rule as an instance rule when a condition part of the reasoning rule is configured of only instance triple patterns, and classifying a reasoning rule as a mixed rule when a condition part of the reasoning rule is a mixture of schema triple patterns and instance triple patterns.

7. The method according to claim 5, wherein step (b) includes the steps of
inducing, in a case of the schema rule, a new schema triple by applying the memory-based reasoning method to the schema rule,
converting, in a case of the mixed rule, the mixed rule into an instance rule by applying the memory-based reasoning method to the mixed rule, and inducing a new instance triple by applying the disk-based distributed/parallel reasoning method to the converted instance rule, and
inducing, in a case of the instance rule, a new instance triple by applying the disk-based distributed/parallel reasoning method to the instance rule.

8. A computer-readable medium recording a program for implementing a hybrid rule reasoning method of a hybrid rule reasoning apparatus, the method comprising the steps of:
when the program is executed by the hybrid rule reasoning apparatus,
(a) classifying an input reasoning rule into at least one of a schema rule, an instance rule, and a mixed rule; and
(b) reasoning the classified reasoning rule in a memory-based reasoning method or a disk-based distributed/parallel reasoning method.
